(19) United States
(12) Patent Application Publication
(10) Pub. No.: US 2012/0124520 A1
(43) Pub. Date: May 17, 2012

(54) Graphical User Interface Component

(75) Inventors: Krystian Samp, Gdynia (PL); Jedrzej Gontarczyk, Sopot (PL); William Mcdaniel, Galway (IE)

(73) Assignee: National University of Ireland, Gatway (IE)

(21) Appl. No.: 13/003,937

(22) PCT Filed: Jul. 8, 2009
(86) PCT No.: PCT/IB09/06192

§ 371 Date: Jan. 13, 2011

(30) Foreign Application Priority Data
Jul. 16, 2008 (IE) S2008/0586

(51) Int. Cl. G06F 3/048

(52) U.S. Cl. 715/834

(57) ABSTRACT

A user interlace component for an electronic device having a display. The user interface component, when instantiated is arranged to provide a representation of a hierarchical structure of interlinked objects arranged in a plurality of levels. The representation is displayed as a plurality of concentric rings, each corresponding to a given one of the plurality of levels. The instance of the user interface component is responsive to user interaction therewith to rotate one of the rings, whereby at least one of the objects is rotated out of view, and the instance of the user interface component is responsive to the user selecting an object in a ring to display a limited number of interlinked objects in a connected ring.

The present invention relates to graphical user interfaces. GUIs, and in particular, a user interface component for navigating a display of icons.

### BACKGROUND OF THE INVENTION

GUI components such as icons, cursors, pop-up menus and boxes enable a user to interact with a software program quickly and easily.

Menu systems such as a list of selections are generally placed in order of popularity in a top-to-bottom linear configuration and may be organised by general headings to facilitate ease of access. However, such linear configurations become difficult to navigate once the list exceeds a certain size.

Alternatively, menu systems can be arranged in radial configurations wherein data is organised in a hierarchical circular fashion using concentric rings, such as hyperbolic views, touch graphs, and pie menus.

U.S. Pat. No. 6,549,219, discloses a radial configuration comprising a hierarchical multiple level pie menu, as illustrated in FIG. 1. The menu is separated into multiple pie segments having associated levels of importance, generally indicating frequency of use. Referring to FIG. 1, level 1 comprises menu item a₁; level 2 comprises menu items b₁ and b₂, each associated with menu item a₁; level 3 comprises menu items c₁ to c₄, each associated with menu item b₁, and menu items c₅ to c₈, each associated with b₂. Thus, for example, on selection of menu item a₁, a user is presented with an option of menu items b₁ and b₂. If menu item b₁ is selected, menu items c₁ to c₄ are presented. Such a radial configuration provides an easily navigable system. However, when the amount of menu items exceeds a certain number, the pie menu becomes cluttered and difficult to read due to limited amount of space in which the menu items may he displayed.

U.S. Pat. No. 7,111,788 provides an alternative radial configuration comprising a hierarchical multiple level ring menu. as illustrated in FIG. 2(a) and FIG. 2(b). The menu is presented as multiple concentric rings, each associated with a level of importance. Referring to FIG. 2(a), level 1 comprises menu item a₁. A plurality of menu items, b₁ to b₄, of a level 2 ring associated with menu item a₁, is displayed on an internal concentric ring.

Once one of the menu items, b₁ to b₄, is selected, in this case, menu item b₃, a level 3 internal concentric ring of menu items, c₁ to c₄, related to the menu item, is displayed, as depicted in FIG. 2(b). Non-active rings are diminished as a user navigates through the menu with only the selected menu item(s) of the previous ring(s) being displayed, making it difficult to retrace a user's path through the menu. Furthermore, when the amount of menu items in each level exceeds a certain number, the display also becomes cluttered and difficult to read due to limited amount of space on each ring.

Although various known implementations such as these differ slightly (e.g. in interaction model or design), they all suffer from a limited amount of space, around the circumference of the ring, or pie segment, and/or on the display screen.

The object of the present invention is to provide a more user-friendly graphical interface, which overcomes the problems associated with the prior art.

### DISCLOSURE OF THE INVENTION

According to a first aspect of the invention, there is provided a user interface component for an electronic device having a display, the component when instantiated being arranged to provide a representation of a hierarchical structure of interlinked objects arranged in a plurality of levels, said representation being displayed as a plurality of concentric rings, each corresponding to a given one of said plurality of levels, the instance of said component being responsive to user interaction therewith to rotate one of said rings whereby at least one of said objects is rotated out of view, and said instance of said component is responsive to said user selecting an object in a ring to display a limited number of interlinked objects in a connected ring.

Preferable, at least one of said rings comprises a limited number of display segments and for said ring, said number of objects exceeds said number of display segments.

Preferably, one or more of said rings is non-continuous.

Preferably, said instance of said component is responsive to said user selecting an object to emphasise said selected object.

Preferably said emphasis is framing said selected object.

Alternatively, said emphasis is highlighting said selected object.

Preferably, said user interface component, when instantiated, is arranged to display a maximum number of rings.

Preferably the number of rings permitted to be displayed in said representation is less than the number of levels in said hierarchical structure, and the instance of said component being responsive to a user interaction to navigate from one level to another by causing said rings to be repositioned within said display of concentric rings, simultaneously revealing a ring not displayed immediately before said user interaction and concealing a ring displayed immediately before said user interaction.

Preferably, said navigation is in a first direction between hierarchical levels, said revealed ring is arranged to be positioned following said user interaction in an outermost position in said concentric display and said concealed ring was a centremost ring in said concentric display immediately before said user interaction.

Alternatively, said navigation is in a second direction between hierarchical levels, said revealed ring is arranged to be positioned following said user interaction in an centremost position in said concentric display and said concealed ring was an outermost ring in said concentric display immediately before said user interaction.

### BRIEF DESCRIPTION OF THE DRAWINGS

FIG. 1 illustrates a known graphical user interface component comprising a hierarchical multiple level pie menu;

FIG. 2(a) illustrates a known graphical user interface comprising a hierarchical multiple level ring menu;

FIG. 2(b) illustrates a further expanded view of the ring menu of FIG. 2(a);

FIG. 3 illustrates an electronic device comprising a graphical user interface according to the preferred embodiment of the present invention;

FIG. 4(a) illustrates a first view of a hierarchical multiple level ring menu of a graphical user interlace according to the preferred embodiment of the present invention;

FIG. 4(b) illustrates a second view of the hierarchical multiple level ring menu of the graphical user interlace of FIG. 4(a);

FIG. 4(c) illustrates a third view of the hierarchical multiple level ring menu of the graphical user interface of FIG. 4(a) and FIG. 4(b);

FIG. 5(a) illustrates another hierarchical multiple level ring menu of a graphical user interface according to the preferred embodiment of the present invention;

FIG. 5(b) illustrates a refocused view of the hierarchical multiple level ring menu of the graphical user interface of FIG. 5(a); and

FIG. 6(a) illustrates a first state of a hierarchical multiple level ring menu of a graphical user interface according to the preferred embodiment of the present invention;

FIG. 6(b) illustrates a second state of the hierarchical multiple level ring menu of FIG. 6(a); and

FIG. 6(c) illustrates a third state oldie hierarchical multiple level ring menu of FIG. 6(a) and FIG. 6(b).

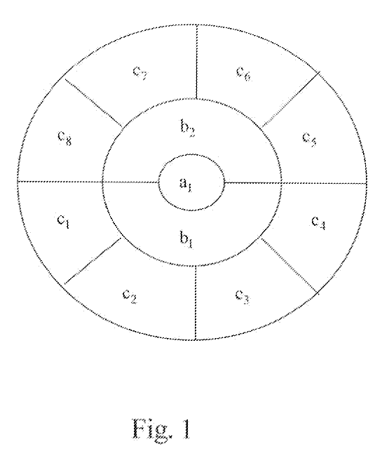

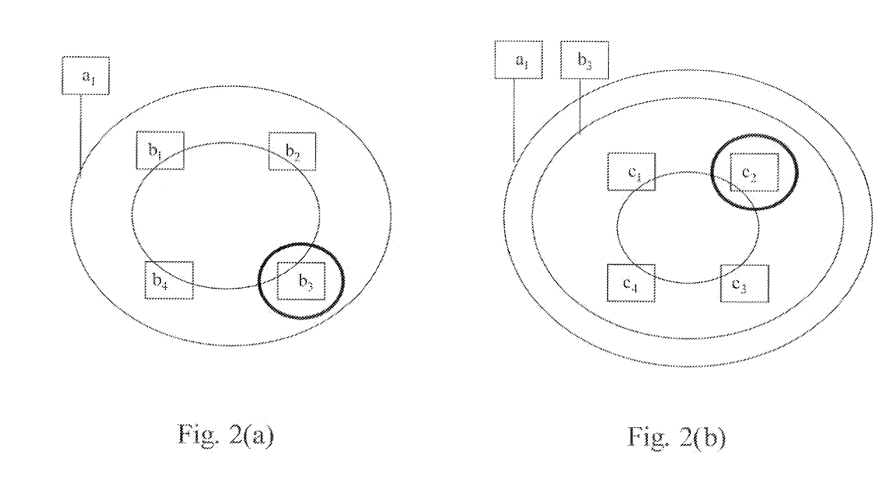

### DESCRIPTION OF THE PREFERRED EMBODIMENTS

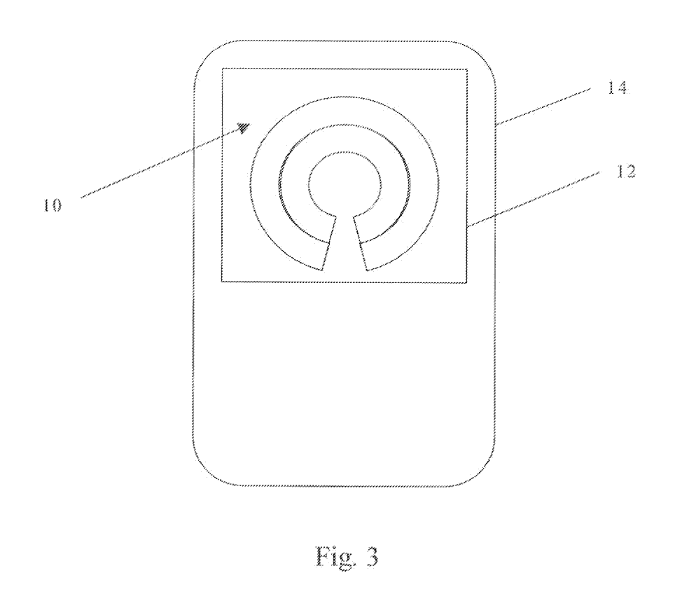

Referring to FIG. 3 of the accompanying drawings, there is illustrated a user interface component 10 presented on a display 12 of an electronic device 14, according to a preferred embodiment of the present invention. The user interface component 10 is presented as a radial configuration comprising a hierarchical multiple level ring menu. In the embodiment shown in FIG. 3, the menu comprises two rings and these rings are non-continuous, being broken at the bottom.

Preferably, an input wheel (not shown), for example a mouse scroll wheel, is associated with the electronic device 14. The input wheel is rotatable liar providing rotary inputs to the device 14 and depressible in a button-like manner for providing selector inputs to the device 14. However, it will be appreciated that an input wheel may be replaced with any suitable means for enabling a user to interact with the user interface component, for example, a standard two-button mouse, a keyboard, etc.

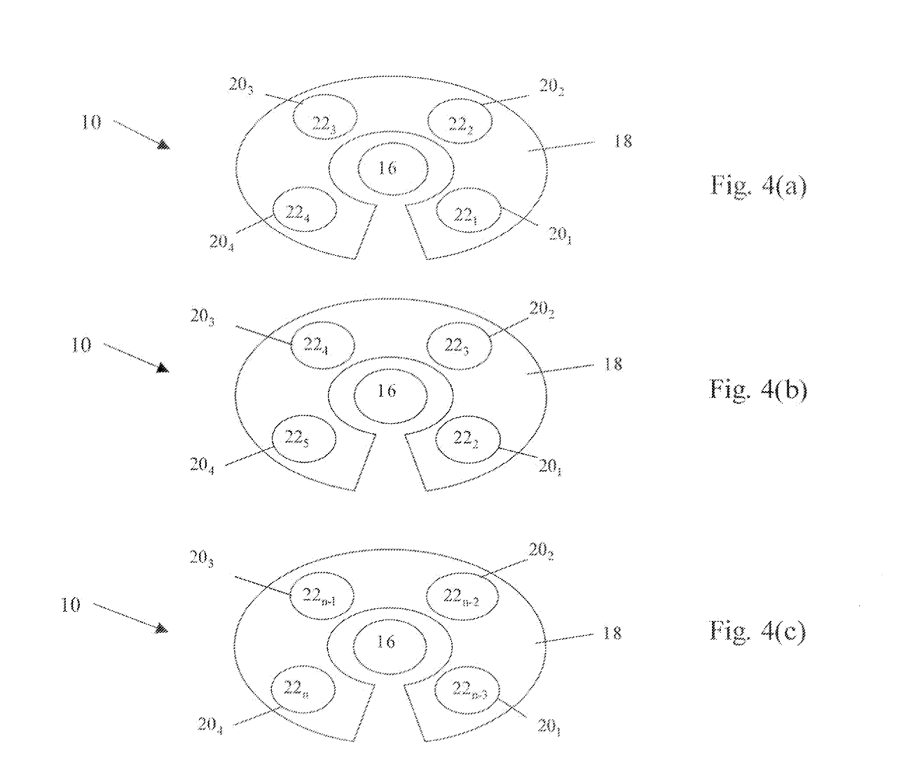

Referring now to FIG. 4(a), the component 10 comprises a root object 16, which represents a highest organisation level and active level of the ring menu.

Upon user selection of said root object, for example, by depressing the wheel input, a concentrically positioned and lower level primary ring 18 is displayed around the root object 16 and becomes the active level of the GUI component 10.

As illustrated in FIG. 4(a), the primary ring 18, associated with a primary level, comprises four display segments 20₁, 20₂, 20₃, and 20₄. Each display segment 20 is occupied by an object, 22₁, 22₂, 22₃, and 22₄, each object being related to the root object 16.

Objects 22₅ to 22ₙ are also associated or belong to the primary level. However due to the fact the primary ring 18 comprises only four display segments, these objects remain out of view of a user.

In the preferred embodiment. as illustrated in FIG. 4(a) to (c), the primary ring 18 is depicted as an open or non-continuous ring. This ring depiction is preferably to a complete or continuous ring or pie chart depiction as it presents a user with an impression that the ring may comprise further objects, not all of which may be viewed at the same time due to the limited display segments on each ring. As such, the display remains uncluttered regardless of the number of objects associated with each level. However, it will be appreciated that in an alternative embodiment, the open rings are replaced with any suitable depiction, for example, continuous rings or wheels.

In the preferred embodiment, in order to view the un-displayed objects 22₅ to 22ₙ, the user may avail of the input wheel to navigate or scroll through the objects, thereby changing the currently visible objects of the ring 18, as illustrated in FIG. 4(b) and FIG. 4(c).

In an alternative embodiment, an indicator, for example, an arced line having arrows pointing in opposite directions, is displayed to further impress upon the user the impression of the rotatable display sections of the ring.

According to the preferred embodiment, a desired object may he indicated to the user for example, by highlighting it, displaying it within a frame, or by any other suitable method. The desired object may then be selected, for example, by depressing the wheel input. In the preferred embodiment, the selected object remains emphasised. In this way, a user can easily identify the previously selected objects and thereby a path navigated through the options provided by the menu.

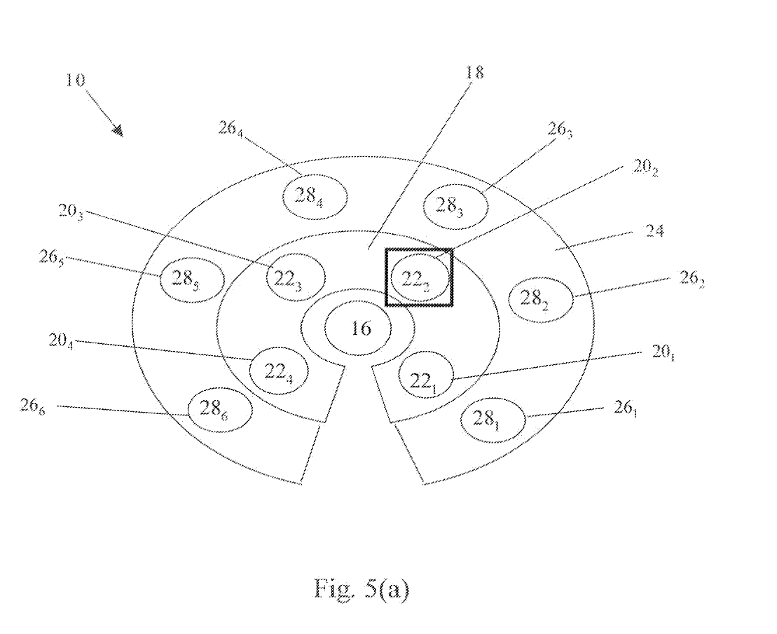

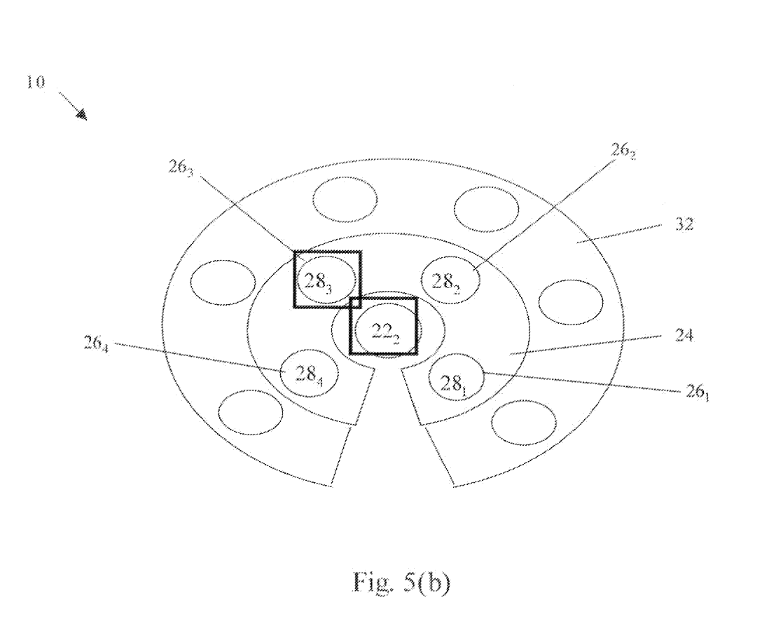

In the preferred embodiment, once the user has selected an object in the primary level, a secondary ring 24, concentric with the primary ring 18, is displayed as illustrated in FIG. 5(a). This secondary ring 24, associated with a secondary level, becomes the active ring of the menu. In the preferred embodiment, the secondary level represents a lower organisation level than that of the primary level associated with the primary ring.

As illustrated in FIG. 5(a), the secondary ring 24, comprises six display segments 26₁ to 26₆. Each display segment 26₁ to 26₆ comprises an object, 28₁ to 28₆, each object being related to the previously selected object from the primary ring 18, in this case framed object 22₂.

As with the primary ring, objects 28₇ to 28ₙ are associated or belong to the secondary level. However due to the fact the ring 24 comprises a limited number of display segments, these objects remain out of view of a user. In order to view the un-displayed objects 28₇ to 28ₙ, the user may avail of the input wheel to navigate or scroll through the objects, thereby changing the currently visible objects of the ring 24.

Again, a desired object in the secondary ring 24 may he indicated to the user selected by depressing the wheel input, thereby causing the GUI component to display a tertiary ring (not shown), comprising objects associated with the selected object. As with the selected object of the primary ring, the selected object of the secondary ring 24 remains emphasised.

This process is continued until the user has navigated throughout the list and arrived at the desired menu option.

A user exploring deep hierarchies will cause the creation of many rings. In order to ensure that the display of objects remains coherent and clear, a limited number of rings are displayed at a time. As such, when the number of levels in the hierarchical structure exceeds the number of rings permitted to be displayed, the user can interact with the component to navigate from one level associated with a revealed ring to another level associated with a concealed ring.

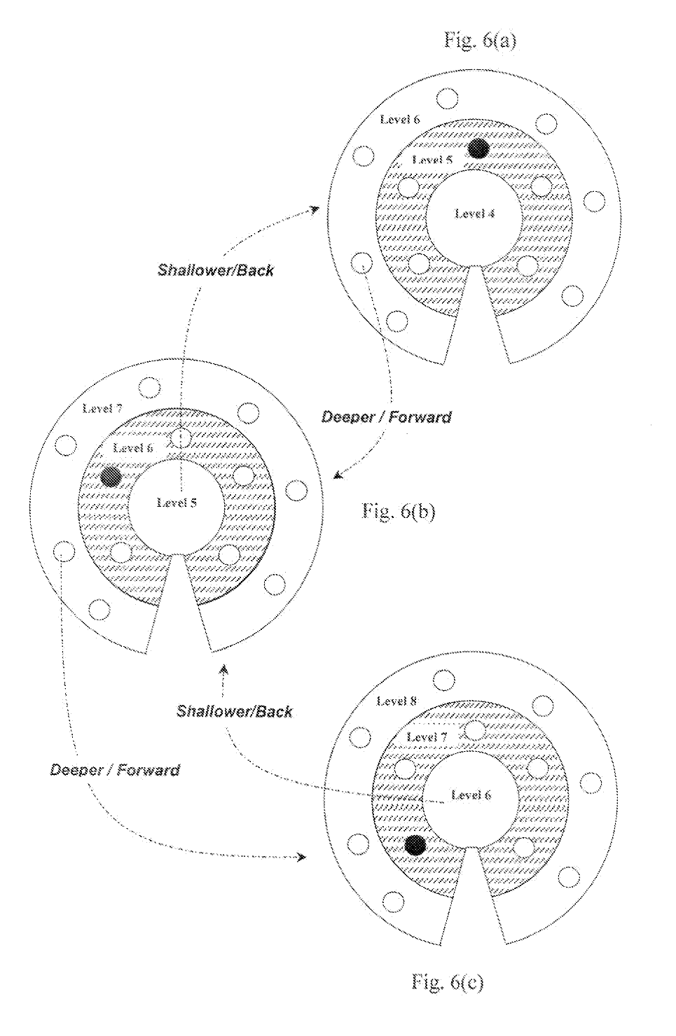

As illustrated in FIGS. 6(a), 6(b) and 6(c), such forward and reverse navigation by a user causes the rings to be repositioned within said display of concentric rings, simultaneously revealing a ring not displayed immediately before said user interaction and concealing a ring displayed immediately before said user interaction.

Thus, as shown, upon user interaction, the display is changed from the state represented by FIG. 6(a) to the state represented by FIG. 6(b). The innermost ring associated with level 4 is concealed, the ring associated with level 5 becomes the centremost ring and an outmost ring associated with level 7 is revealed. Similarly to reveal the ring associated with level 8 as illustrated in FIG. 6(c), the innermost ring associated with level 5 is concealed, and the ring associated with level 6 becomes the centremost ring.

In an alternative embodiment, following user interaction, the revealed ring is positioned in a centremost ring in the concentric display and the concealed ring was an outermost ring in the concentric display immediately before the user interaction

More specifically, and in the preferred embodiment as illustrated in FIGS. 5(a) and 5(b), upon selection of an object within a secondary ring 24, in this case, 28₃, and thereby production of a tertiary ring 32, the user interlace component focuses its central point around the previously selected object front the primary ring, in this case 22₂, such that it replaces the root object, 16, thereby shifting the rings, 24 and 32, of the displayed menu towards the centre. As such, the root object 16 is no longer visible to the user.

Since the selected object from the primary ring, in this case 22₂, replaces the root object 16 as the central point of the menu displayed, the secondary ring 24 becomes the primary ring, and the tertiary ring 32 becomes the secondary ring.

As the user navigates deeper within the hierarchical levels of the menu, the graphical user interface component 10 refocuses its central point to ensure most recent and therefore those most closely associated objects to the active level of the ring are visible to the user.

In the preferred embodiment, the user can return the display to its previous state, and thereby retrace their steps through the menu, by selecting an object in the ring next to the active level. However, it will be appreciated that the display may be returned to its previous state by any suitable means, for example, upon user selection of the central point or a specifically designated ‘back’ button.

It will be appreciated that the number of rings of the menu displayed at one time may be fixed at any suitable number, and may for example be dependent on the size of the objects being displayed.

It will also be appreciated that the number of ring display segments and objects will vary depending on the menu being depicted by the GUI component 10.

It will he appreciated that other navigation and selection devices, such as conventional keyboards or touch screens, may he used to interface with the GUI component 10 of the present invention.

It will he further appreciated that objects to be displayed may he represented in various different manners. An object could be represented by a disjointed shape, may he enlarged, or may be coloured, for example, in order to reflect varying importance, frequency of selection, or other attributes associated with the object. For example, frequently selected objects may be enlarged with respect to other objects in the ring, and objects, which are rarely selected, may be reduced in size with respect to the other objects. In one embodiment, this resizing of the objects is performed dynamically, in response to the frequency of selection.

The invention is not limited to the embodiment(s) described herein but can be amended or modified without departing from the scope of the present invention.

1. A user interface component for an electronic device having a display, the component when instantiated being arranged to provide a representation of a hierarchical structure of interlinked objects arranged in a plurality of levels, said representation being displayed as a plurality of concentric rings, each corresponding to a given one of said plurality of levels, the instance of said component being responsive to user interaction therewith to rotate one of said rings, whereby at least one of said objects is rotated out of view, and said instance of said component is responsive to said user selecting an object in a ring to display a limited number of interlinked objects in a connected ring.

2. The user interface component of claim 1, wherein at least one of said rings comprises a limited number of display segments and for said ring, said number of objects exceeds said number of display segments.

3. The user interface component of claim 1, wherein one or more of said rings is non-continuous.

4. The user interface component of claim 1, wherein said instance of said component is responsive to said user selecting an object to emphasise said selected object.

5. The user interface component claim 4, wherein said emphasis is framing said selected object.

6. The user interface of component claim 4, wherein said emphasis is highlighting said selected object.

7. The user interface of claim 1, wherein said user interface component, when instantiated, is arranged to display a limited number of rings.

8. The user interface of claim 1, wherein the number of rings permitted to be displayed in said representation is less than the number of levels in said hierarchical structure, the instance of said component being responsive to a user interaction to navigate from one level to another by causing said rings to he repositioned within said display of concentric rings, simultaneously revealing a ring not displayed immediately before said user interaction and concealing a ring displayed immediately before said user interaction.

9. The user interface of claim 8, wherein said navigation is in a first direction between hierarchical levels, said revealed ring being arranged to be positioned following said user interaction in an outermost position in said concentric display and wherein said concealed ring was a centremost ring in said concentric display immediately before said user interaction.

10. The user interface of claim 8, wherein said navigation is in a second direction between hierarchical levels, said revealed ring being arranged to be positioned following said user interaction in an centremost position in said concentric display and wherein said concealed ring was an outermost ring in said concentric display immediately before said user interaction.
